(19) United States
(12) Patent Application Publication
(10) Pub. No.: US 2025/0131616 A1
(43) Pub. Date: Apr. 24, 2025

(54) METHOD FOR VISUALIZING CUTTING PATH IN SIMULATION APPARATUS AND SIMULATION DEVICE FOR PERFORMING THE SAME

(71) Applicant: Korea Advanced Institute of Science and Technology, Daejeon (KR)

(72) Inventors: Jinah Park, Daejeon (KR); Taeyun Woo, Daejeon (KR)

(73) Assignee: Korea Advanced Institute of Science and Technology, Daejeon (KR)

(21) Appl. No.: 18/922,567

(22) Filed: Oct. 22, 2024

(30) Foreign Application Priority Data
Oct. 24, 2023 (KR) 10-2023-0142734

(51) Int. Cl. G06T 11/20; G05B 17/02; G05B 19/19; G06T 15/04

(52) U.S. Cl. CPC G06T 11/203; G05B 17/02; G05B 19/19; G06T 15/04

(57) ABSTRACT

A method for visualizing a cutting path in a simulation apparatus includes setting a first point representing a start of the cutting tool and a second point representing an end of the cutting tool, obtaining a third point representing an intersection of the target object and the cutting tool based on the first point and the second point, calculating an incident depth and an incident angle of the cutting tool based on a normal vector that is orthogonal to a first plane of the target object including the third point, the first point, the second point, and the third point, generating a normal map based on the incident angle, the incident depth, a first depth representing a maximum depth at which the target object is able to be cut by the cutting tool, and the third point, and visualizing the cutting path representing lines obtained by connecting the third points.

### PRIORITY STATEMENT

This application claims priority under 35 U.S.C. § 119 to Korean Patent Application No. 10-2023-0142734, filed on Oct. 24, 2023 in the Korean Intellectual Property Office KIPO, the contents of which are herein incorporated by reference in their entireties.

### BACKGROUND

### 1. Field

Embodiments of the present disclosure relate to the field of computer graphics, and more particularly, to a method for visualizing a cutting path in a simulation apparatus and a simulation apparatus for performing the same.

### 2. Description of the Related Art

With the development of technologies such as computer graphics and digital twins, a technical barrier to simulation of real-world objects in a virtual environment is gradually lowering. In particular, since a process of cutting an object in real world has to be performed safely and efficiently, learning is often performed through virtual simulation. There is an increasing demand for realistic cutting simulation for environments that require a high level of safety and precision, such as a surgical procedure, nuclear power plant decommissioning, and a disaster environment. In addition, due to the nature of virtual application, it is important to show a cutting process in real time in response to the user's interaction. Therefore, many researches for effectively and efficiently visualizing a cutting process in virtual cutting simulation are being conducted.

### SUMMARY

Embodiments of the present disclosure provide a method for visualizing a cutting path in a simulation apparatus, capable of realistically visualizing the cutting path with a small amount of calculation.

Embodiments of the present disclosure provide a simulation apparatus for performing a method for visualizing a cutting path efficiently and effectively.

In an embodiment of a method for visualizing a cutting path in a simulation apparatus, which is for cutting a target object by using a cutting tool in a virtual environment according to the present disclosure, the method includes setting a first point representing a start portion of the cutting tool and a second point representing an end portion of the cutting tool, obtaining a third point representing an intersection of the target object and the cutting tool based on the first point and the second point, calculating an incident depth and an incident angle of the cutting tool based on a normal vector that is orthogonal to a first plane of the target object including the third point, the first point, the second point, and the third point, generating a normal map based on the incident angle, the incident depth, a first depth representing a maximum depth at which the target object is able to be cut by the cutting tool, and the third point and visualizing the cutting path representing lines obtained by connecting a plurality of third points to each other based on normal maps generated as a result of repeatedly performing the obtaining of the third point, the calculating of the incident depth and the incident angle, and the generating of the normal map.

In an embodiment of a simulation apparatus for cutting a target object by using a cutting tool in a virtual environment according to the present disclosure, the simulation apparatus includes an input module configured to receive an input of a user and transmit an input signal to a controller, the controller configured to transmit a cutting image signal to a display module based on the input signal and the display module configured to provide image information to the user based on the cutting image signal. The controller includes a first module configured to periodically set a first point representing a start portion of the cutting tool and a second point representing an end portion of the cutting tool based on the input signal, and obtain a third point representing an intersection of the target object and the cutting tool based on the first point and the second point, a second module configured to receive the first point, the second point, and the third point from the first module, and calculate an incident depth and an incident angle of the cutting tool based on a normal vector that is orthogonal to a first plane of the target object including the third point, the first point, the second point, and the third point, a third module configured to receive the third point from the first module, receive the incident depth and the incident angle from the second module, and generate a normal map based on the incident angle, the incident depth, a first depth representing a maximum depth at which the target object is able to be cut by the cutting tool, and the third point and a fourth module configured to receive normal maps, which are generated as a result of repeatedly performing an operation of obtaining the third point by the first module, an operation of calculating the incident depth and the incident angle by the second module, and an operation of generating the normal map by the third module, from the third module, and generate the cutting image signal for visualizing a cutting path representing lines obtained by connecting a plurality of third points to each other based on the normal maps.

According to the method for visualizing the cutting path in the simulation apparatus of embodiments of the present disclosure described above, the cutting path may be visualized by using a normal map without modifying a mesh of a target object, so that the cutting path can be expressed realistically with a small amount of calculation.

### BRIEF DESCRIPTION OF THE DRAWINGS

The above and other features and advantages of the present disclosure will become more apparent by describing in detailed embodiments thereof with reference to the accompanying drawings, in which:

FIG. 1 is a flowchart showing a method for visualizing a cutting path in a simulation apparatus according to embodiments of the present disclosure;

FIGS. 2 and 3 are views for describing setting of a first point and a second point in the method for visualizing the cutting path in the simulation apparatus according to the embodiments of the present disclosure;

FIG. 4 is a view for describing obtaining of a third point in the method for visualizing the cutting path in the simulation apparatus according to the embodiments of the present disclosure;

FIG. 5 is a view for describing calculating of an incident depth and an incident angle in the method for visualizing the cutting path in the simulation apparatus according to the embodiments of the present disclosure;

FIG. 6 is a flowchart showing one example of the obtaining of the third point in the method for visualizing the cutting path in the simulation apparatus according to the embodiments of the present disclosure;

FIGS. 7 and 8 are views for describing one example of the obtaining of the third point in the method for visualizing the cutting path in the simulation apparatus according to the embodiments of the present disclosure;

FIG. 9 is a flowchart showing one example of the obtaining of the third point in the method for visualizing the cutting path in the simulation apparatus according to the embodiments of the present disclosure;

FIG. 10 is a flowchart showing one example of generating of a normal map in the method for visualizing the cutting path in the simulation apparatus according to the embodiments of the present disclosure;

FIGS. 11 and 12 are views for describing one example of the generating of the normal map in the method for visualizing the cutting path in the simulation apparatus according to the embodiments of the present disclosure;

FIG. 13 is a flowchart showing one example of the calculating of the incident depth and the incident angle in the method for visualizing the cutting path in the simulation apparatus according to the embodiments of the present disclosure;

FIG. 14 is a flowchart showing one example of obtaining of the incident depth in the method for visualizing the cutting path in the simulation apparatus according to the embodiments of the present disclosure;

FIG. 15 is a flowchart showing one example of the generating of the normal map in the method for visualizing the cutting path in the simulation apparatus according to the embodiments of the present disclosure;

FIGS. 16, 17, 18, 19, 20, and 21 are views for describing one example of the generating of the normal map in the method for visualizing the cutting path in the simulation apparatus according to the embodiments of the present disclosure;

FIG. 22 is a block diagram showing a simulation apparatus according to embodiments of the present disclosure; and

FIG. 23 is a block diagram showing one example of the simulation apparatus according to the embodiments of the present disclosure.

### DETAILED DESCRIPTION OF THE EMBODIMENTS

The present disclosure now will be described more fully hereinafter with reference to the accompanying drawings, in which embodiments of the present disclosure are shown. The present disclosure may, however, be embodied in many different forms and should not be construed as limited to the embodiments set forth herein.

Rather, these embodiments are provided so that this disclosure will be thorough and complete, and will fully convey the scope of the present disclosure to those skilled in the art. Like reference numerals refer to like elements throughout.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present disclosure.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the inventive concept as used herein.

Hereinafter, the present disclosure will be explained in detail with reference to the accompanying drawings.

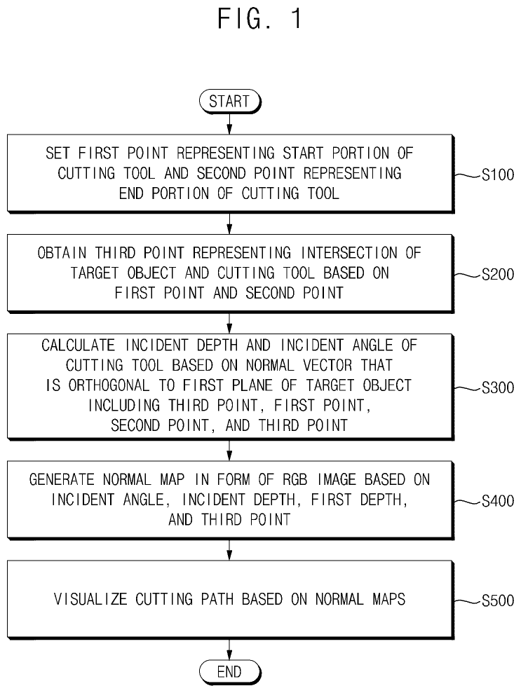

FIG. 1 is a flowchart showing a method for visualizing a cutting path in a simulation apparatus according to embodiments of the present disclosure.

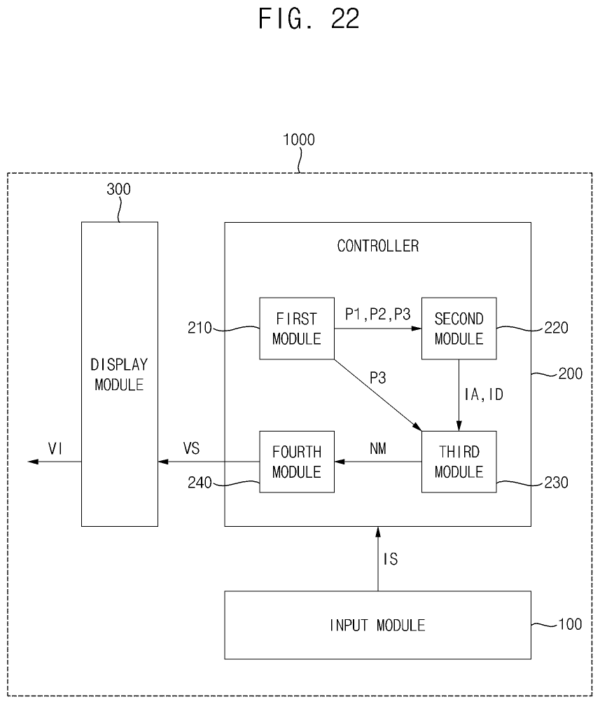

Referring to FIG. 1, a method for visualizing a cutting path in a simulation apparatus according to embodiments of the present disclosure may be performed by a simulation apparatus for cutting a target object by using a cutting tool in a virtual environment. For example, the target object may be a three-dimensional object expressed in the form of a mesh. The specific configuration of the simulation apparatus will be described below with reference to FIG. 22.

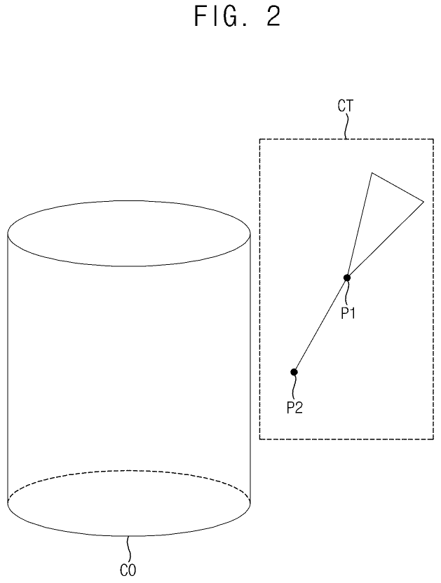

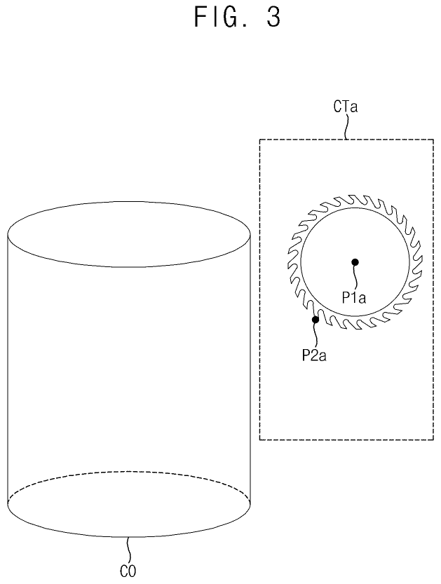

According to the embodiments of the present disclosure, a first point representing a start portion of the cutting tool and a second point representing an end portion of the cutting tool may be set (step S100). The cutting tool may be replaced with two points to obtain an intersection of the target object and the cutting tool with a small amount of calculation. For example, the first point and the second point may be used to generate a ray in graphics pipeline-based ray casting. Specific examples of the first point and the second point will be described below with reference to FIGS. 2 and 3.

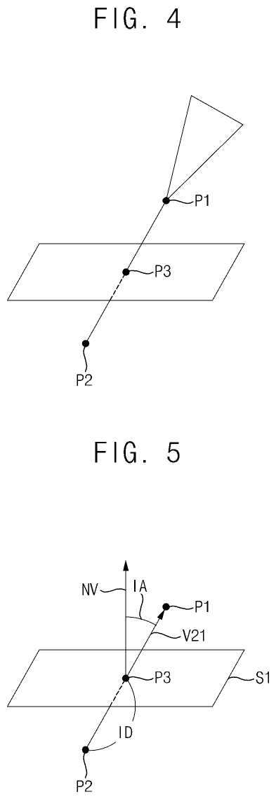

A third point representing an intersection of the target object and the cutting tool may be obtained based on the first point and the second point (step S200). For example, the third point may be obtained by using the graphics pipeline-based ray casting. For example, a ray that connects the first point to the second point may be generated, and coordinates of an intersection of the ray and a mesh triangle of the target object that has collided with the ray may be obtained. A specific example of the third point will be described below with reference to FIG. 4.

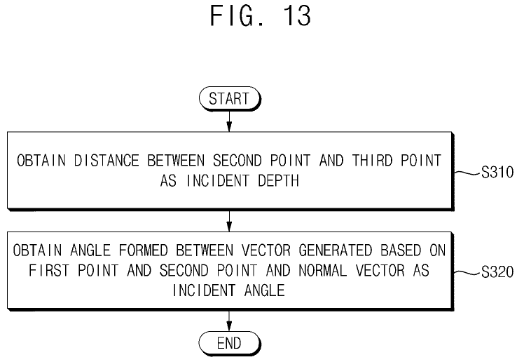

An incident depth and an incident angle of the cutting tool may be calculated based on a normal vector that is orthogonal to a first plane of the target object including the third point, the first point, the second point, and the third point (step S300). For example, as will be described below with reference to FIG. 13, the incident depth may be obtained based on the second point and the third point, and the incident angle may be obtained based on the first point, the second point, and the normal vector. Specific examples of the incident depth and the incident angle will be described below with reference to FIG. 5.

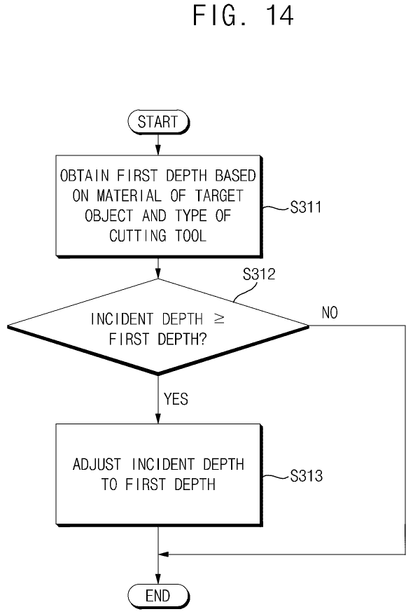

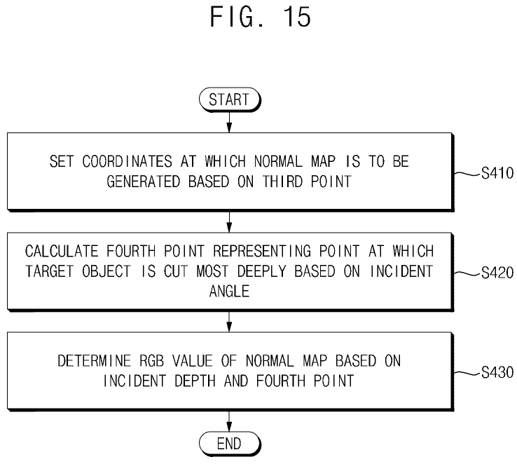

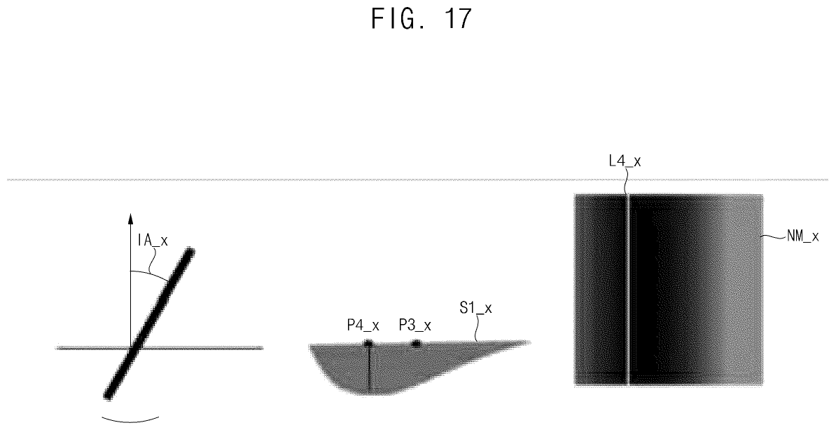

A normal map in the form of an RGB image may be generated based on the incident angle, the incident depth, a first depth, and the third point (step S400). For example, the first depth may represent a maximum depth at which the target object may be cut by the cutting tool, and may be preset at an initial stage of a simulation operation. The calculation of the first depth will be described below with reference to FIG. 14. For example, the normal map may represent a type of texture applied to a mesh representing a 3D object. For example, the normal map may perform specific visualization of a surface of an object that is not represented by a mesh. For example, the normal map may be generated with respect to a normal direction (e.g., a vertical direction) indicated by a surface of the target object. For example, a red (R) value, a green (G) value, and a blue (B) value of the normal map may correspond to an X value, a Y value, and a Z value of a three-dimensional coordinate system, respectively. In this case, the R value and the G value may represent a width and a length, respectively, and the B value may represent a height. For example, each of the R value, the G value, and the B value may have one integer value from 0 to 255, and a case in which each of the R value, the G value, and the B value is 127 may represent a case in which the surface of the object does not have any change. For example, a case in which the B value is less than 127 may represent a protrusion or embossing in the vertical direction of the surface of object, and a case in which the B value is greater than 127 may represent a depression or engraving on the surface of the object. For example, when only the height of the cutting path is adjusted, each of the R value and the G value may be 127, and only the B value may be adjusted. For example, according to the present disclosure, the surface of the object may be engraved, so that B values of all pixels of the normal map may be greater than 127. For example, as will be described below with reference to FIG. 16, the normal map may be an RGB image having a size of 1024×1024. The specific process of generating the normal map based on the incident angle, the incident depth, the first depth representing the maximum depth at which the target object may be cut by the cutting tool, and the third point will be described below with reference to FIGS. 16 to 21.

The cutting path may be visualized based on normal maps (step S500). The normal maps may be generated as a result of repeatedly performing the steps S200, S300, and S400. For example, each of the steps S200, S300, and S400 may be performed periodically. For example, the steps S200, S300, and S400 may be performed in an environment of 30 frame per second (fps). In this case, 30 normal maps may be generated per second. For example, the cutting path may represent lines obtained by connecting a plurality of third points to each other. For example, when the steps S200, S300, and S400 are performed in the environment of 30 fps, 30 third points may be obtained, and 29 lines obtained by connecting two temporally neighboring points among the 30 third points may be obtained. In this case, the 29 lines may be substantially identical to the cutting path. According to one embodiment, the normal maps may be aligned to match directions of the lines.

According to the method for visualizing the cutting path in the simulation apparatus of the embodiments of the present disclosure described above, the cutting path may be visualized by using a normal map without modifying a mesh of a target object, so that the cutting path may be expressed realistically with a small amount of calculation.

FIGS. 2 and 3 are views for describing setting of a first point and a second point in the method for visualizing the cutting path in the simulation apparatus according to the embodiments of the present disclosure.

Referring to FIG. 2, one example of a target object CO and a cutting tool CT may be shown. For example, the target object CO may be in the form of a 3D mesh. For example, the cutting tool CT may be set as a first point P1 and a second point P2 in the simulation apparatus. For example, as shown in FIG. 2, the cutting tool CT may be a water jet cutter. In this case, the first point P1 may be set as a portion at which a water stream starts, and the second point P2 may be set as a portion at which the water stream ends.

Referring to FIG. 3, another example of a cutting tool CTa may be shown. For example, as shown in FIG. 3, the cutting tool CTa may be a circular saw. In this case, a first point P1a may be set as a rotation center of the circular saw, and a second point P2a may be set as an end portion of the circular saw. Although the method for visualizing the cutting path has been described based on a case in which the cutting tool is a water jet cutter in the present disclosure, the embodiments are not limited thereto.

FIG. 4 is a view for describing obtaining of a third point in the method for visualizing the cutting path in the simulation apparatus according to the embodiments of the present disclosure.

Referring to FIG. 4, an operation of obtaining a third point P3 based on the first point P1 and the second point P2 may be shown. For example, the third point P3 may be obtained by using graphics pipeline-based ray casting. For example, a ray that connects the first point P1 to the second point P2 may be generated. In this case, the first point P1 may be a start point of the ray, and the second point P2 may be used when determining a direction vector of the ray. For example, coordinates of a surface of the target object that has collided with the ray may be obtained as the third point P3.

FIG. 5 is a view for describing calculating of an incident depth and an incident angle in the method for visualizing the cutting path in the simulation apparatus according to the embodiments of the present disclosure.

Referring to FIG. 5, an operation of calculating an incident depth ID and an incident angle IA based on a normal vector NV, the first point P1, the second point P2, and the third point P3 may be shown. The normal vector NV may represent an arbitrary vector that is orthogonal to a first plane S1 of the target object including the third point P3.

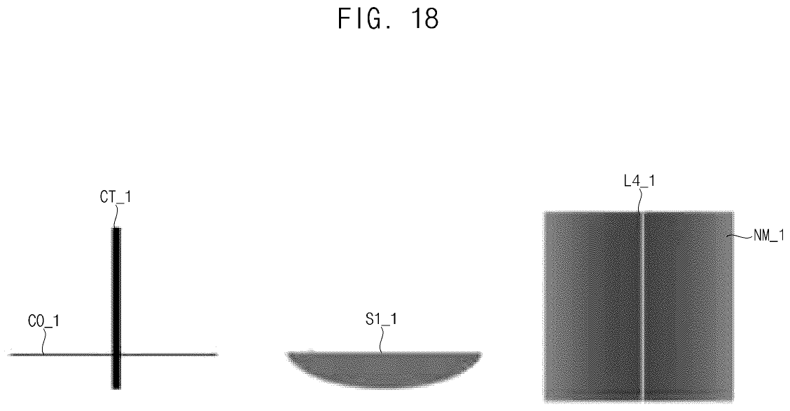

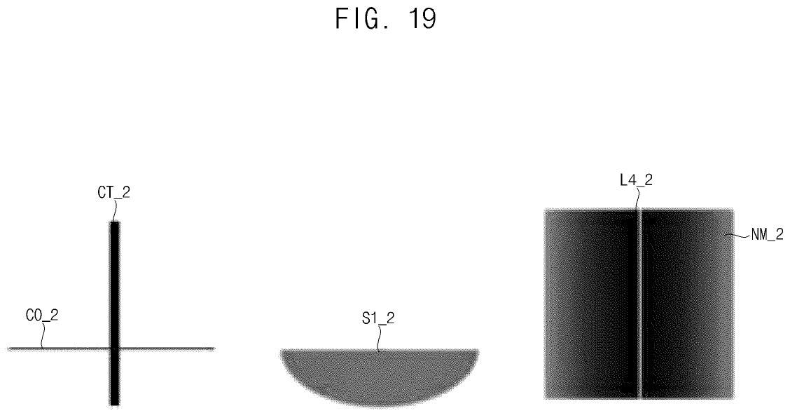

For example, the incident depth ID may be calculated as a distance between the second point P2 and the third point P3. For example, the incident depth ID may represent a depth at which the cutting tool has passed through the first plane S1. As will be described below with reference to FIGS. 18 and 19, the incident depth ID may be used to determine an RGB value of a normal map.

For example, the incident angle IA may be calculated as an angle formed between a vector V21 in which a start point is the second point P2 and an end point is the first point P1 and the normal vector NV. For example, the incident angle IA may be calculated based on an inner product of the vector V21 in which the start point is the second point P2 and the end point is the first point P1 and the normal vector NV. As will be described below with reference to FIG. 17, the incident angle IA may be used to calculate a fourth point representing a point at which the target object is cut most deeply.

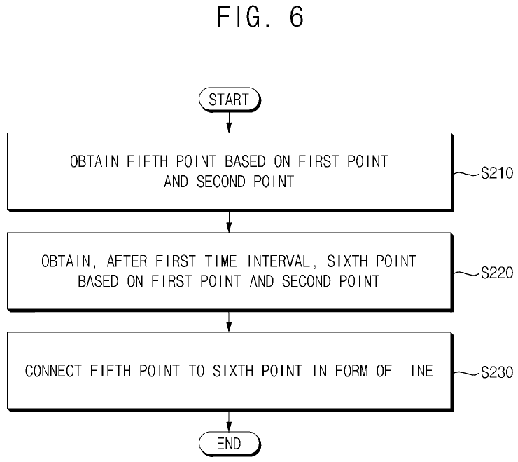

FIG. 6 is a flowchart showing one example of the obtaining of the third point in the method for visualizing the cutting path in the simulation apparatus according to the embodiments of the present disclosure.

Referring to FIG. 6, steps S210, S220, and S230 may represent one example of the step S200 of FIG. 1. A fifth point and a sixth point may be included in a plurality of third points obtained by periodically and repeatedly performing the step S200 of FIG. 1, and, in this case, a period may be expressed as a first time interval.

A fifth point may be obtained based on the first point and the second point (step S210). For example, the fifth point may be included in the third points, and may represent an intersection of the target object and the cutting tool.

After a first time interval from a time at which the fifth point is obtained, a sixth point may be obtained based on the first point and the second point (step S220). For example, the sixth point may represent an intersection obtained after the fifth point among the third points repeatedly obtained at the first time interval. For example, the first time interval may be 1/30 second in an environment of 30 fps.

The fifth point and the sixth point may be connected in the form of a line (step S230). The line obtained by connecting the fifth point to the sixth point may be one of the lines obtained by connecting the third points to each other, which are described above with reference to FIG. 1.

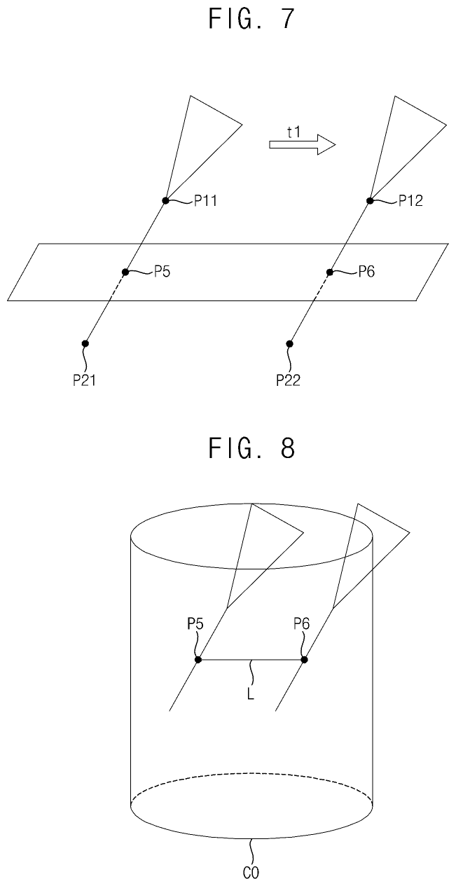

FIGS. 7 and 8 are views for describing one example of the obtaining of the third point in the method for visualizing the cutting path in the simulation apparatus according to the embodiments of the present disclosure.

Referring to FIG. 7, an operation of obtaining a fifth point P5 and an operation of obtaining a sixth point P6 after a first time interval t1 may be shown. For example, the fifth point P5 may be obtained based on a first point P11 and a second point P21. After the first time interval t1 from a time at which the fifth point P5 is obtained, the sixth point P6 may be obtained based on a first point P12 and a second point P22.

Referring to FIG. 8, a line L located on a surface of the target object CO and obtained by connecting the fifth point P5 to the sixth point P6 may be shown. For example, a set of lines L may represent the cutting path. For example, the line L may be used to align a normal map generated about the fifth point P5. For example, as will be described below with reference to FIG. 17, an operation of visualizing the cutting path based on normal maps may include an operation of aligning the normal map so that a line segment including the fourth point may be parallel to the line L. The cutting path may be expressed more realistically in a case in which the alignment operation is performed than a case in which the alignment operation is not performed.

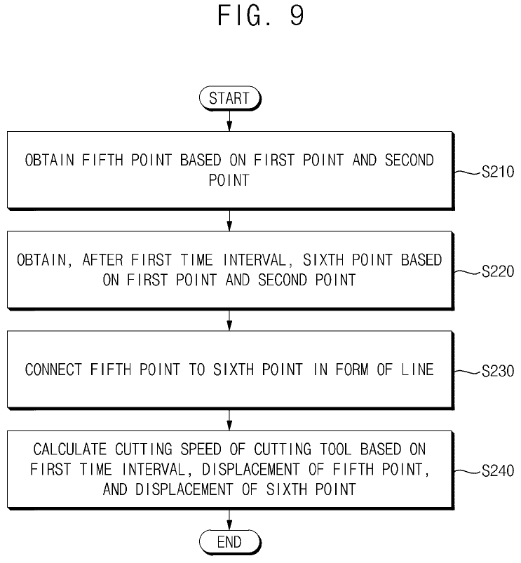

FIG. 9 is a flowchart showing one example of the obtaining of the third point in the method for visualizing the cutting path in the simulation apparatus according to the embodiments of the present disclosure.

Referring to FIG. 9, steps S210, S220, S230, and S240 may represent one example of the step S200 of FIG. 1. The steps S210, S220, and S230 may be substantially identical to the steps S210, S220, and S230 of FIG. 6. Hereinafter, redundant descriptions corresponding to FIG. 6 will be omitted.

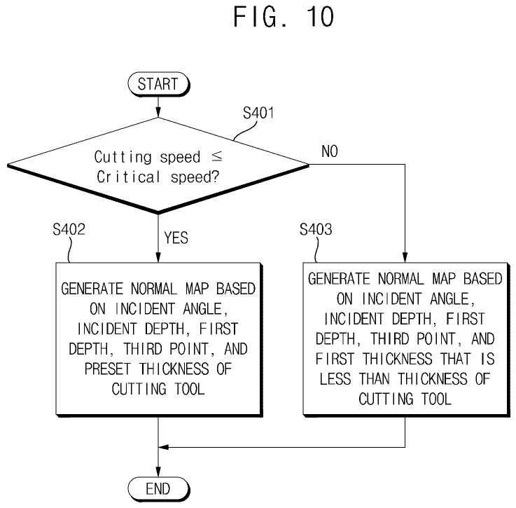

A cutting speed of the cutting tool may be calculated based on the first time interval, a displacement of the fifth point, and a displacement of the sixth point (S240). For example, the first time interval may represent a period at which the step S200 of FIG. 1 is performed. As will be described below with reference to FIG. 10, the cutting speed and a critical speed may be compared with each other to adjust the RGB value of the normal map. For example, the cutting speed may be calculated as a value obtained by dividing a difference between the displacement of the sixth point and the displacement of the fifth point by the first time interval. For example, when the displacement difference between the sixth point and the fifth point is 0.001 mm in the environment of 30 fps, the first time interval may be obtained as 1/30 second, and the cutting speed may be calculated as 0.03 mm/sec.

FIG. 10 is a flowchart showing one example of generating of a normal map in the method for visualizing the cutting path in the simulation apparatus according to the embodiments of the present disclosure.

Referring to FIG. 10, steps S401, 402, and 403 may represent one example of the step S400 of FIG. 1. An operation of additionally considering a thickness of the cutting tool or a first thickness based on the cutting speed when the normal map is generated may be shown.

The cutting speed and the critical speed may be compared with each other (step S401). For example, the critical speed may represent a maximum speed of the cutting tool to engrave the surface of the target object by the thickness of the cutting tool. For example, when the cutting tool passes rapidly over the surface of the target object, before the surface of the target object is engraved by the thickness of the cutting tool, the cutting tool may move away from the surface of the target object being engraved. When the cutting tool passes rapidly over the surface of the target object, the surface of the target object may be engraved by a thickness that is less than the thickness of the cutting tool.

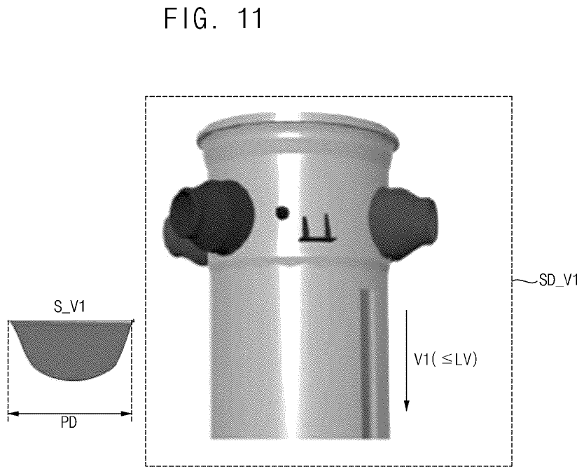

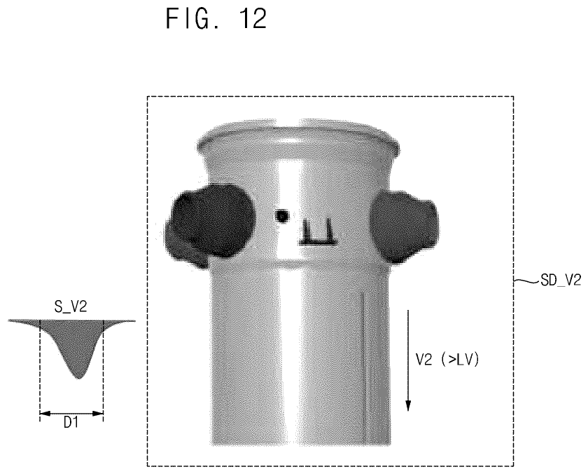

When the cutting speed is less than or equal to the critical speed (step S401: Yes), the normal map may be generated based on the incident angle, the incident depth, the first depth, the third point, and a preset thickness of the cutting tool (step S402). For example, a case in which the cutting speed is less than or equal to the critical speed may represent a case in which the surface of the target object is engraved by the thickness of the cutting tool. For example, the thickness of the cutting tool may be used in a polynomial function-based interpolation operation. A specific example of the visualization based on the thickness of the cutting tool will be described below with reference to FIG. 11.

When the cutting speed is greater than the critical speed (step S401: No), the normal map may be generated based on the incident angle, the incident depth, the first depth, the third point, and a first thickness that is less than the thickness of the cutting tool (step S403). For example, a case in which the cutting speed is greater than the critical speed may represent a case in which the surface of the target object is not engraved by the thickness of the cutting tool. For example, the first thickness may be set to have a value that is gradually decreased as the cutting speed increases. For example, the first thickness may be set to be inversely proportional to a difference between the speed of the cutting tool and the critical speed. For example, the first thickness may be set by a user. For example, the first thickness may be used in the polynomial function-based interpolation operation. A specific example of the visualization based on the first thickness will be described below with reference to FIG. 12.

FIGS. 11 and 12 are views for describing one example of the generating of the normal map in the method for visualizing the cutting path in the simulation apparatus according to the embodiments of the present disclosure.

Referring to FIG. 11, one example of a surface S_V1 of the target object and a simulation display SD_V1 when a cutting speed V1 of the cutting tool is less than or equal to a critical speed LV may be shown. For example, the surface S_V1 of the target object may be engraved in the form of a polynomial function based on a thickness PD of the cutting tool. For example, when the normal map is generated, the polynomial function-based interpolation operation may be performed in consideration of the thickness PD of the cutting tool. For example, the simulation display SD_V1 may display a shape of the target object engraved by the thickness PD of the cutting tool.

Referring to FIG. 12, one example of a surface S_V2 of the target object and a simulation display SD_V2 when a cutting speed V2 of the cutting tool is greater than the critical speed LV may be shown. For example, the surface S_V2 of the target object may be engraved in the form of a polynomial function based on a first thickness D1 that is less than the thickness of the cutting tool. For example, when the normal map is generated, the polynomial function-based interpolation operation may be performed in consideration of the first thickness D1. For example, the simulation display SD_V2 may display a shape of the target object engraved thinner than the thickness of the cutting tool.

FIG. 13 is a flowchart showing one example of the calculating of the incident depth and the incident angle in the method for visualizing the cutting path in the simulation apparatus according to the embodiments of the present disclosure.

Referring to FIG. 13, steps S310 and S320 may represent one example of the step S300 of FIG. 1.

A distance between the second point and the third point may be obtained as the incident depth (S310). For example, the incident depth may represent a depth at which the cutting tool enters the surface of the target object in an opposite direction of the normal vector. An angle formed between a vector generated based on the first point and the second point and the normal vector may be obtained as the incident angle (S320). For example, the incident angle may be obtained through the inner product between the vectors as described above with reference to FIG. 5.

FIG. 14 is a flowchart showing one example of obtaining of the incident depth in the method for visualizing the cutting path in the simulation apparatus according to the embodiments of the present disclosure.

Referring to FIG. 14, steps S311, S312, and S313 may represent one example of the step S310 of FIG. 13. An operation of adjusting the incident depth based on the first depth after the incident depth is obtained may be shown.

The first depth may be obtained based on a material of the target object and a type of cutting tool (step S311). The first depth may represent a maximum depth at which the target object may be cut by the cutting tool. For example, when the material of the target object is stainless steel, and the cutting tool is a water jet cutter, the first depth may be set to 0.5 cm. In this case, the incident depth representing the depth at which the cutting tool enters the surface of the target object in the opposite direction of the normal vector may be adjusted to have a value that is less than the first depth.

The incident depth and the first depth may be compared with each other (step S312). When the incident depth is greater than or equal to the first depth (step S312: Yes), the incident depth may be adjusted to the first depth. For example, when the first depth is 0.5 cm, and the incident depth is 1 cm, the incident depth may be adjusted to 0.5 cm. When the incident depth is less than the first depth (step S312: No), the step S300 may end. For example, when the first depth is 0.5 cm, and the incident depth is 0.3 cm, the incident depth may not be adjusted.

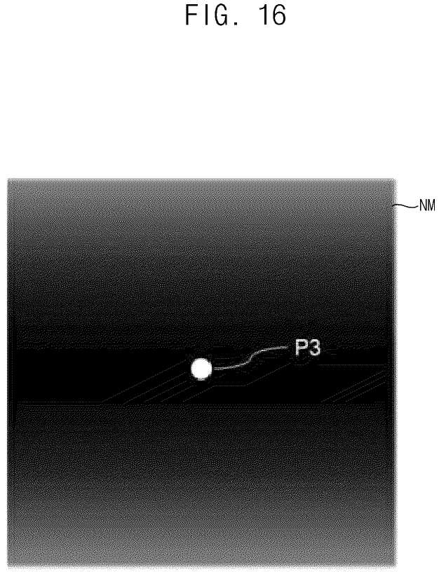

FIG. 15 is a flowchart showing one example of the generating of the normal map in the method for visualizing the cutting path in the simulation apparatus according to the embodiments of the present disclosure.

Referring to FIG. 15, steps S410, S420, and S430 may represent one example of the step S400 of FIG. 1.

Coordinates at which the normal map is to be generated may be set based on the third point (step S410). For example, the normal map may be generated by using coordinates of the third point as a center point. For example, when the simulation apparatus uses a three-dimensional Cartesian coordinate system, and the coordinates of the third point are (0,0,0), a normal map in the form of an image having a size of 1024×1024 and using (0,0,0) as a center point may be generated. For example, the third point may correspond to (512,512) pixel coordinates in the normal map. For example, a direction of the normal map in a three-dimensional coordinate system may match a direction of the first plane (S1 of FIG. 5) described above with reference to FIG. 5. However, as described above with reference to FIGS. 1 and 8, the direction of the normal map may be aligned to be parallel to a line segment obtained by connecting two points among the third points in the step S500 of FIG. 1.

A fourth point representing a point at which the target object is cut most deeply may be calculated based on the incident angle (step S420). For example, the fourth point may represent a portion in which the surface of the target object is indented most deeply. An RGB value of the normal map is determined based on the incident depth and the fourth point (step S430). For example, a B value of a line segment including the fourth point on the normal map may be set to be the largest. For example, the B value of the line segment including the fourth point may be set to 255, and a B value at a periphery of the line segment may be set by using polynomial function-based interpolation. A specific operation of calculating the fourth point will be described below with reference to FIG. 17.

FIGS. 16, 17, 18, 19, 20, and 21 are views for describing one example of the generating of the normal map in the method for visualizing the cutting path in the simulation apparatus according to the embodiments of the present disclosure.

Referring to FIG. 16, a normal map NM generated about a third point P3 may be shown. For example, the normal map NM may be in the form of an image having a width size of 1024 pixels and a length size of 1024 pixels. In this case, the third point P3 may represent a 512th pixel in width and a 512th pixel in length of the normal map NM. Therefore, the third point P3 may have coordinates of (512,512) on the normal map NM.

Referring to FIG. 17, a process of calculating a fourth point P4_x based on an incident angle IA_x may be shown. For example, a degree by which the fourth point P4_x is spaced apart from a third point P3_x may be set based on the incident angle IA_x. For example, a surface S1_x of the target object may be engraved most deeply at the fourth point P4_x rather than the third point P3_x. For example, a position of the fourth point P4_x may be calculated by [Equation 1].

$$S 4 = sin ( I A ) * NM S [ pixel ] \qquad [ Equation 1 ]$$

In [Equation 1], S4 may represent a degree by which a fourth point is spaced apart from a third point, and S4 may be calculated in a unit of a pixel. IA may represent an incident angle, and NMS may represent a width or length size of a normal map.

For example, when a size of a normal map NM_x is 1024×1024, and the incident angle IA_x is 30°, the fourth point P4_x may be spaced apart from the third point P3_x by sin (30°)×512 pixels. In this case, a line segment LA_x including the fourth point on the normal map NM_x may represent a set of (256, n) pixels (where n is a natural number up to 1024). For example, a B value of the line segment LA_x including the fourth point may be set to the largest value within the normal map NM_x, and a B value at a periphery of the line segment LA_x including the fourth point may be calculated through the polynomial function-based interpolation.

When comparing FIGS. 18 and 19 with each other, a difference between normal maps NM_1 and NM_2 according to a difference in the incident depth may be shown.

Referring to FIG. 18, a surface S1_1 of a target object according to a depth at which a cutting tool CT_1 is incident on the target object CO_1 and a normal map NM_1 for visualizing the surface S1_1 of the target object may be shown. For example, a B value of a line segment L4_1 including a fourth point may be calculated by [Equation 2].

$$B = 127 + \frac{ID}{D 1} * 128 \qquad [ Equation 2 ]$$

In [Equation 2], B may represent a B value of a normal map, ID may represent an incident depth, and D1 may represent a first depth. D1 may be preset based on a material of the target object and a type of cutting tool as described above with reference to FIG. 14, and B may be gradually increased as ID increases. For example, since B always represents a cutting case, B may be always greater than 127.

Referring to FIG. 19, a surface S1_2 of a target object according to a depth at which a cutting tool CT_2 is incident on the target object CO_2 and a normal map NM_2 for visualizing the surface S1_2 of the target object may be shown. For example, when compared with the cutting tool CT_1 of FIG. 18, the cutting tool CT_2 may have the same incident angle (0°) with a different incident depth. For example, a B value of a line segment L4_2 including a fourth point may be calculated by [Equation 2]. For example, in order to visualize the surface S1_2 of the target object as being indented deeper than the surface S1_1 of the target object of FIG. 18, the B value of the line segment L4_2 including the fourth point may be set to be greater than the B value of the line segment LA_1 including the fourth point of FIG. 18.

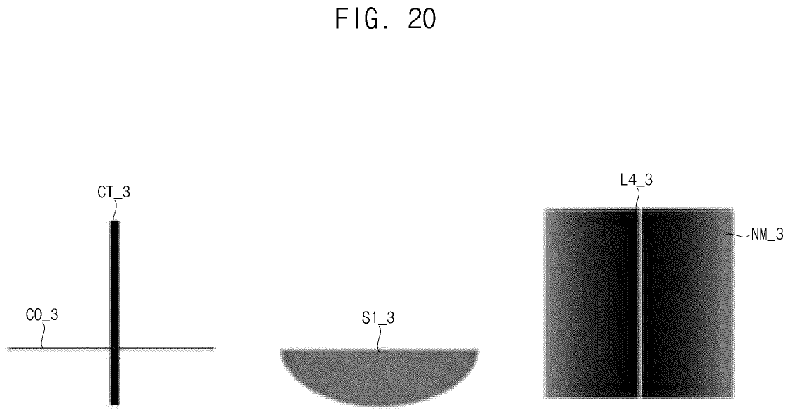

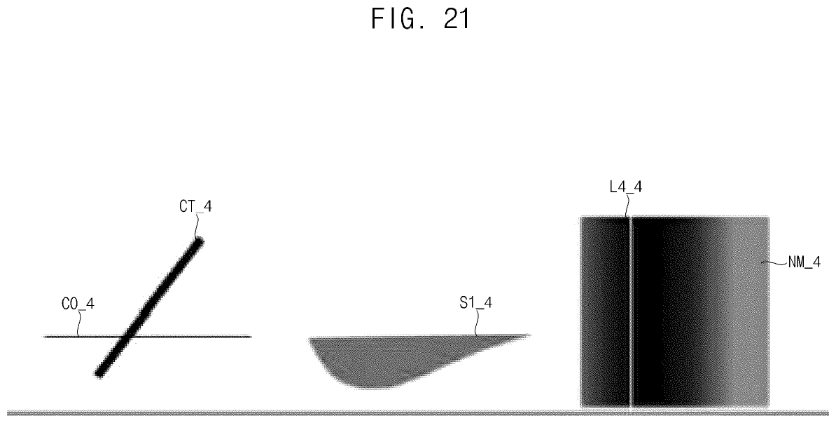

When comparing FIGS. 20 and 21 with each other, a difference between normal maps NM_3 and NM_4 according to a difference in the incident angle may be shown.

Referring to FIG. 20, a surface S1_3 of a target object according to an angle at which a cutting tool CT_3 is incident on the target object CO_3 and a normal map NM_3 for visualizing the surface S1_3 of the target object may be shown. For example, a case in which the incident angle is 0° may be shown. Hereinafter, redundant descriptions corresponding to FIG. 19 will be omitted.

Referring to FIG. 21, a surface S1_4 of a target object according to an angle at which a cutting tool CT_4 is incident on the target object CO_4 and a normal map NM_4 for visualizing the surface S1_4 of the target object may be shown. For example, when compared with the cutting tool CT_3 of FIG. 20, the cutting tool CT_4 may have the same incident depth with a different incident angle. For example, a position of a line segment L4_4 including a fourth point may be different from a position of a line segment L4_3 including a fourth point of FIG. 20. For example, the position of the line segment L4_4 including the fourth point may be obtained as described above with reference to FIG. 17. For example, in order to visualize the surface S1_4 of the target object as being cut at a different angle from the surface S1_3 of the target object of FIG. 20, the position of the line segment L4_4 including the fourth point may be set to be biased to a left side as compared with the position of the line segment L4_3 including the fourth point of FIG. 20.

FIG. 22 is a block diagram showing a simulation apparatus according to embodiments of the present disclosure.

Referring to FIG. 22, a simulation apparatus 1000 may include an input module 100, a controller 200, and a display module 300. The controller 200 may include a first module 210, a second module 220, a third module 230, and a fourth module 240.

The simulation apparatus 1000 may be an apparatus for performing cutting simulation of cutting a target object by using a cutting tool in a virtual environment.

The input module 100 may include a three-dimensional input apparatus such as a haptic apparatus and a mouse. For example, the input module 100 may detect an input (e.g., a movement) of a user to convert the input into an input signal IS, and transmit the input signal IS to the controller 200.

The controller 200 may operate based on the input signal IS, and may transmit a cutting image signal VS for visualizing a cutting path based on a normal map to the display module 300.

The display module 300 may receive the cutting image signal VS from the controller 200, and provide image information VI to the user based on the cutting image signal VS.

The first module 210 may perform the steps S100 and S200 of FIG. 1. For example, the first module 210 may periodically set a first point P1 representing a start portion of the cutting tool and a second point P2 representing an end portion of the cutting tool based on the input signal IS, and obtain a third point P3 representing an intersection of the target object and the cutting tool based on the first point P1 and the second point P2.

The second module 220 may perform the step S300 of FIG. 1. For example, the second module 220 may receive the first, second, and third points P1, P2, and P3 from the first module 210. For example, the second module 220 may calculate an incident depth ID and an incident angle IA of the cutting tool based on a normal vector that is orthogonal to a first plane of the target object including the third point P3, the first point P1, the second point P2, and the third point P3.

The third module 230 may perform the step S400 of FIG. 1. For example, the third module 230 may receive the third point P3 from the first module 210, and receive the incident depth ID and the incident angle IA from the second module 220. For example, the third module 230 may generate a normal map NM in the form of an RGB image based on the incident depth ID, the incident angle IA, a first depth, and the third point.

The fourth module 240 may perform the step S500 of FIG. 1. For example, the fourth module 240 may receive normal maps NM, which are generated as a result of repeatedly performing an operation of obtaining the third point P3 by the first module 210, an operation of calculating the incident depth ID and the incident angle IA by the second module 220, and an operation of generating the normal map NM by the third module 230, from the third module 230, and generate the cutting image signal VS for visualizing a cutting path based on the normal maps NM.

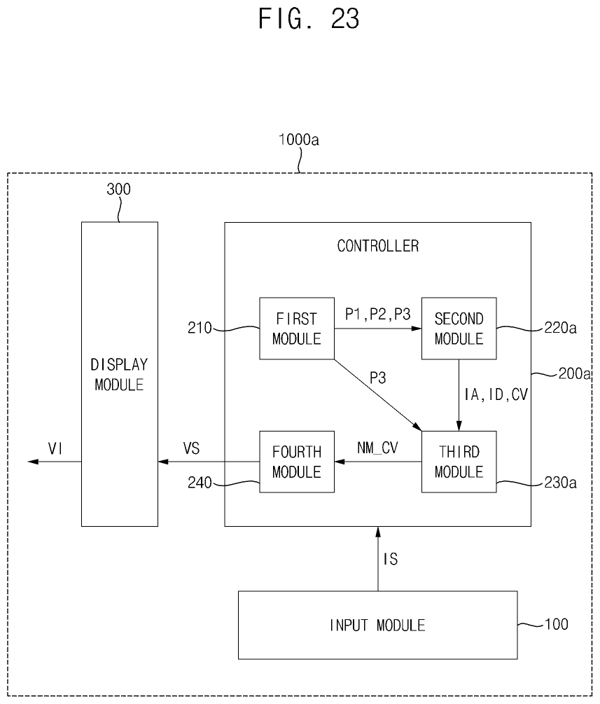

FIG. 23 is a block diagram showing one example of the simulation apparatus according to the embodiments of the present disclosure.

Referring to FIG. 23, a simulation apparatus 1000a may represent one embodiment of the simulation apparatus 1000 of FIG. 22. The simulation apparatus 1000a may perform an operation of additionally considering a cutting speed CV when a normal map NM_CV is generated. The simulation apparatus 1000a may include an input module 100, a controller 200a, and a display module 300. The controller 200a may include a first module 210, a second module 220a, a third module 230a, and a fourth module 240. The input module 100, the display module 300, the first module 210, and the fourth module 240 may be substantially identical to the input module 100, display module 300, the first module 210, and the fourth module 240 of FIG. 22.

The second module 220a may perform the step S240 of FIG. 9. The second module 220a may calculate a cutting speed CV of the cutting tool based on a first time interval and a plurality of third points.

The third module 230a may perform the steps S401, S402, and S403 of FIG. 10. The third module 230a may generate a normal map NM_CV based on the cutting speed CV, the incident angle IA, the incident depth ID, a first depth representing a maximum depth at which the target object may be cut by the cutting tool, and the third point P3.

The foregoing is illustrative of the present inventive concept and is not to be construed as limiting thereof. Although a few embodiments of the present inventive concept have been described, those skilled in the art will readily appreciate that many modifications are possible in the embodiments without materially departing from the novel teachings and advantages of the present inventive concept. Accordingly, all such modifications are intended to be included within the scope of the present inventive concept as defined in the claims. In the claims, means-plus-function clauses are intended to cover the structures described herein as performing the recited function and not only structural equivalents but also equivalent structures. Therefore, it is to be understood that the foregoing is illustrative of the present inventive concept and is not to be construed as limited to the specific embodiments disclosed, and that modifications to the disclosed embodiments, as well as other embodiments, are intended to be included within the scope of the appended claims. The present inventive concept is defined by the following claims, with equivalents of the claims to be included therein.

1. A method for visualizing a cutting path in a simulation apparatus, which is for cutting a target object by using a cutting tool in a virtual environment, the method comprising:
setting a first point representing a start portion of the cutting tool and a second point representing an end portion of the cutting tool;
obtaining a third point representing an intersection of the target object and the cutting tool based on the first point and the second point;
calculating an incident depth and an incident angle of the cutting tool based on a normal vector that is orthogonal to a first plane of the target object including the third point, the first point, the second point, and the third point;
generating a normal map based on the incident angle, the incident depth, a first depth representing a maximum depth at which the target object is able to be cut by the cutting tool, and the third point; and
visualizing the cutting path representing lines obtained by connecting a plurality of third points to each other based on normal maps generated as a result of repeatedly performing the obtaining of the third point, the calculating of the incident depth and the incident angle, and the generating of the normal map.

2. The method of claim 1, wherein the obtaining of the third point includes:
obtaining a fifth point included in the third points and representing an intersection of the target object and the cutting tool based on the first point and the second point;
obtaining, after a first time interval from a time at which the fifth point is obtained, a sixth point included in the third points and representing an intersection of the target object and the cutting tool based on the first point and the second point; and
connecting the fifth point to the sixth point in a form of a line.

3. The method of claim 2, wherein the obtaining of the third point further includes:
calculating a cutting speed of the cutting tool based on the first time interval, a displacement of the fifth point, and a displacement of the sixth point.

4. The method of claim 3, wherein the generating of the normal map includes:
generating, when the cutting speed is less than or equal to a critical speed, the normal map based on the incident angle, the incident depth, the first depth, the third point, and a preset thickness of the cutting tool; and
generating, when the cutting speed is greater than the critical speed, the normal map based on the incident angle, the incident depth, the first depth, the third point, and a first thickness that is less than the preset thickness of the cutting tool.

5. The method of claim 1, wherein the calculating of the incident depth and the incident angle includes:
obtaining a distance between the second point and the third point as the incident depth; and
obtaining an angle formed between a vector generated based on the first point and the second point and the normal vector as the incident angle.

6. The method of claim 5, wherein the obtaining of the incident depth includes:
obtaining the first depth based on a preset material of the target object and a preset type of the cutting tool; and
adjusting, when the incident depth is greater than or equal to the first depth, the incident depth to the first depth.

7. The method of claim 1, wherein the generating of the normal map includes:
setting coordinates at which the normal map is to be generated based on the third point;
calculating a fourth point representing a point at which the target object is cut most deeply based on the incident angle; and
determining an RGB value of the normal map based on the incident depth and the fourth point.

8. The method of claim 7, wherein the setting of the coordinates at which the normal map is to be generated based on the third point includes:
generating the normal map by using coordinates of the third point as a center point.

9. The method of claim 7, wherein the fourth point is calculated based on [Equation 1]:
$$S 4 = s in ( IA ) * NMS [ pixel ] , and ,$$
in [Equation 1], S4 represents a degree by which a fourth point is spaced apart from a third point, IA represents an incident angle, and NMS represents a width or length size of a normal map.

10. The method of claim 7, wherein the normal map is generated in a form of an RGB image,
a B value of a line segment located on the normal map and including the fourth point is calculated based on [Equation 2]:
$$B = 127 + \frac{ID}{D 1} * 128 , and ,$$
in [Equation 2], B represents a B value, ID represents an incident depth, and D1 represents a first depth.

11. The method of claim 1, wherein the generating of the normal map includes:
generating the normal map based on polynomial function-based interpolation.

12. The method of claim 1, wherein the obtaining of the third point includes:
obtaining the third point by using graphics pipeline-based ray casting.

13. The method of claim 12, wherein the obtaining of the third point includes:
generating a ray that connects the first point to the second point; and
obtaining an intersection of the ray and the target object that has collided with the ray as the third point.

14. The method of claim 1, wherein the cutting tool includes a water jet cutter.

15. The method of claim 14, wherein the setting of the first point and the second point includes:
setting the first point as a portion at which a water stream of the water jet cutter starts; and
setting the second point as a portion at which the water stream of the water jet cutter ends.

16. The method of claim 1, wherein the cutting tool includes a circular saw.

17. The method of claim 16, wherein the setting of the first point and the second point includes:
setting the first point as a rotation center of the circular saw; and
setting the second point as an end portion of the circular saw.

18. A simulation apparatus for cutting a target object by using a cutting tool in a virtual environment, the simulation apparatus comprising:
an input module configured to receive an input of a user and transmit an input signal to a controller;
the controller configured to transmit a cutting image signal to a display module based on the input signal; and
the display module configured to provide image information to the user based on the cutting image signal,
wherein the controller includes:
a first module configured to periodically set a first point representing a start portion of the cutting tool and a second point representing an end portion of the cutting tool based on the input signal, and obtain a third point representing an intersection of the target object and the cutting tool based on the first point and the second point;
a second module configured to receive the first point, the second point, and the third point from the first module, and calculate an incident depth and an incident angle of the cutting tool based on a normal vector that is orthogonal to a first plane of the target object including the third point, the first point, the second point, and the third point;
a third module configured to receive the third point from the first module, receive the incident depth and the incident angle from the second module, and generate a normal map based on the incident angle, the incident depth, a first depth representing a maximum depth at which the target object is able to be cut by the cutting tool, and the third point; and
a fourth module configured to receive normal maps, which are generated as a result of repeatedly performing an operation of obtaining the third point by the first module, an operation of calculating the incident depth and the incident angle by the second module, and an operation of generating the normal map by the third module, from the third module, and generate the cutting image signal for visualizing a cutting path representing lines obtained by connecting a plurality of third points to each other based on the normal maps.

19. The simulation apparatus of claim 18, wherein the second module is configured to calculate a cutting speed of the cutting tool based on a first time interval and the third points, and
the third module is configured to generate the normal map based on the cutting speed, the incident angle, the incident depth, the first depth by the cutting tool, and the third point.

20. A method for visualizing a cutting path in a simulation apparatus, which is for cutting a target object by using a cutting tool in a virtual environment, the method comprising:
a first step of setting a first point representing a start portion of the cutting tool and a second point representing an end portion of the cutting tool;
a second step of obtaining a third point representing an intersection of the target object and the cutting tool based on the first point and the second point;
a third step of obtaining a distance between the second point and the third point as an incident depth;
a fourth step of obtaining an angle formed between a vector generated based on the first point and the second point and a normal vector that is orthogonal to a first plane of the target object including the third point as an incident angle;
a fifth step of setting coordinates at which a normal map is to be generated based on the third point;
a sixth step of calculating a fourth point representing a point at which the target object is cut most deeply based on the incident angle;
a seventh step of generating the normal map having an RGB value determined based on the incident depth and the fourth point; and
an eighth step of visualizing the cutting path representing lines obtained by connecting a plurality of third points to each other based on normal maps generated as a result of repeatedly performing the first to seventh steps.
